(19) United States
(12) Patent Application Publication
(10) Pub. No.: US 2010/0275611 A1
(43) Pub. Date: Nov. 4, 2010

(54) Distributing Fuel Flow in a Reaction Chamber

(76) Inventor: Edan Prabhu, Mission Viejo, CA (US)

Correspondence Address: FISH & RICHARDSON P.C., P.O. BOX 1022, MINNEAPOLIS, MN, 55440-1022, US

(21) Appl. No.: 12/772,622

(22) Filed: May 3, 2010

Related U.S. Application Data
(60) Provisional application No. 61/174,857, filed on May 1, 2009.

(51) Int. Cl. F02C 7/22

(52) U.S. Cl. 60/780; 60/39.12

(57) ABSTRACT

A substantially homogeneous air/fuel mixture is distributed into an oxidation reaction chamber at a plurality of discrete locations about an interior of the oxidation reaction chamber. The oxidation reaction chamber has an internal temperature sufficient to oxidize the fuel in the air/fuel mixture. The air/fuel mixture are retained in the oxidation reaction chamber as the fuel of the air/fuel mixture oxidizes. The heat released by the oxidation maintains a temperature substantially throughout the reaction chamber at a temperature sufficient to oxidize the fuel in the air/fuel mixture.

### CROSS-REFERENCE TO RELATED APPLICATIONS

This application is related to and claims the benefit of co-pending provisional application Ser. No. 61/174,857 entitled “Oxidizer,” filed May 1, 2009, which is incorporated herein by reference.

### BACKGROUND

This disclosure relates to distributing an air/fuel mixture in a reaction chamber, for example, a reaction chamber of a gas turbine system. Some conventional gas turbine systems rapidly combust fuel as the fuel is injected into air in a combustion chamber. After the fuel has combusted, a turbine extracts energy from the combusted fuel by converting thermal energy into kinetic energy. The kinetic energy may be used to drive another device, for example, a generator. The fuel combustion process is often maintained by an ignition source (e.g., a spark plug). Due to the high temperature of the ignition source and the high concentration of the fuel as it mixes with the air in the combustion chamber, the combustion process is very rapid and nearly instantaneous. Some gas turbine systems combust fuel at a slower rate. For example, catalyst materials in the combustion chamber may slow the rate of combustion (e.g., platinum). In other types of conventional systems, a thermal oxidizer for destroying waste materials (i.e., not used with gas turbine systems) may oxidize fuel at lower temperatures and/or at a slower rate.

### SUMMARY

In a general aspect, an air/fuel mixture is distributed to multiple locations in a reaction chamber. The fuel is oxidized in the reaction chamber. A wide range of fuels may be oxidized in a manner that reduces, minimizes, or eliminates emission of harmful or unwanted materials.

In some aspects, a system for oxidizing a wide range of fuels includes an oxidation reaction chamber. The oxidation reaction chamber has an inlet arranged to receive a substantially homogeneous air/fuel mixture. A gas distributor system is provided in the oxidation reaction chamber and coupled to the inlet. The gas distributor system is adapted to distribute the air/fuel mixture at a plurality of discrete locations throughout the interior of the oxidation reaction chamber such that when the fuel of the distributed air/fuel mixture is oxidized in the reaction chamber, heat released by the oxidation maintains a temperature substantially throughout the reaction chamber at a temperature sufficient to oxidize the fuel in the air/fuel mixture.

In some aspects, a substantially homogeneous air/fuel mixture, the fuel component of which comes from a wide range of fuels, is distributed into an oxidation reaction chamber at a plurality of discrete locations about an interior of the oxidation reaction chamber. The oxidation reaction chamber has an internal temperature sufficient to oxidize the fuel in the air/fuel mixture. The air/fuel mixture oxidizes in the reaction chamber and heat released by the oxidation maintains a temperature substantially throughout the reaction chamber sufficient to oxidize the fuel in the air/fuel mixture.

In some aspects, a gas turbine system includes an oxidation reaction chamber. A gas distributor system is provided in the oxidation reaction chamber and arrange to receive a substantially homogeneous air/fuel mixture. The gas distributor system has a plurality of ports adapted to output the air/fuel mixture into an interior of the oxidation reaction chamber. The ports are arrange substantially throughout the oxidation reaction chamber. A turbine generator has a turbine inlet in communication with an outlet of the oxidation reaction chamber. The turbine generator is adapted to convert energy from the oxidize fuel into electricity.

The details of one or more embodiments of these concepts are set forth in the accompanying drawings and the description below. Other features, objects, and advantages of these concepts will be apparent from the description and drawings, and from the claims.

### DESCRIPTION OF DRAWINGS

FIG. 1 is a diagram of an example gas turbine system.

FIGS. 2A and 2B are diagrams of an example reaction chamber.

FIGS. 2C and 2D are diagrams showing aspects of the example gas distributor 207 of FIGS. 2A and 2B.

FIG. 2E is a diagram of the example supplemental gas distributor of FIGS. 2A and 2B.

FIGS. 3A, 3B, 3C and 3D are diagrams of example reaction chambers.

FIG. 4 is a flow chart of an example technique for oxidizing fuel.

Like reference symbols in the various drawings indicate like elements.

### DETAILED DESCRIPTION

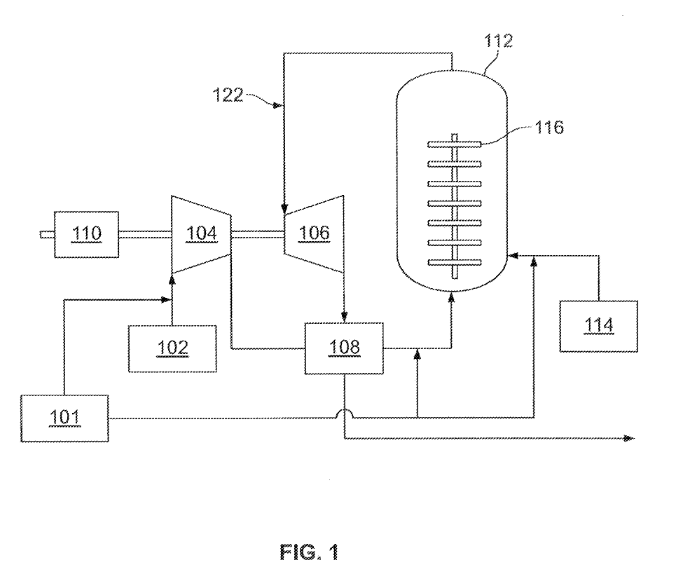

FIG. 1 is a diagram of an example gas turbine system 100. The example system 100 can oxidize fuel and use the heat energy released by the oxidation process to generate rotational mechanical energy and/or to generate electrical power. The example gas turbine system 100 can generate energy by oxidizing fuel in a gas mixture. The system 100 may oxidize the fuel while reducing or eliminating the production of greenhouse gases and/or other undesirable or harmful materials. For example, the system 100 can oxidize fuel in a manner that reduces or eliminates emission of nitrogen oxides (NOx), carbon monoxide (CO), volatile organic compounds (VOCs), and/or other types of potentially harmful gases. For example, temperatures above 2300 degrees Fahrenheit (° F.) may cause nitrogen oxides to form, and the system 100 can reduce or eliminate formation of nitrogen oxides by maintaining a maximum temperature of the fuel below 2300° F. during sustained operation. As another example, incomplete oxidation of hydrocarbons may cause carbon monoxide to form, and the system 100 can reduce or eliminate production of carbon monoxide by completely or nearly completely oxidizing hydrocarbon fuel to water (H₂O) and carbon dioxide (CO₂) products. As such, the system 100 may completely oxidize fuel, so that little or no fuel is wasted or emitted into the environment.

The example system 100 oxidizes the fuel component of a gas mixture in a reaction chamber 112 defined by the interior perimeter of a vessel. A gas distributor system 116 in the reaction chamber 112 facilitates the oxidation process. The gas distributor system 116 distributes a gas mixture containing fuel and air and perhaps other gases through an oxidation zone in the reaction chamber where the fuel component of the gas mixture is oxidized. For example, the distributor system 116 may communicate the gas into the oxidation zone at multiple locations along a flow path through the reaction chamber 112. As such, the gas distributor system 116 may help sustain a complete or near complete oxidation of fuel within a desired temperature range, for example, at temperatures sufficiently high to oxidize the fuel component but sufficiently low in order to prevent or reduce production of undesirable or harmful materials. By distributing the gas in multiple locations in the oxidation zone, the reaction chamber 112 can sustain oxidation by receiving heat from the reaction chamber but imparting heat of oxidation back to the reaction chamber to sustain a continuous oxidation process as additional gas flows into the reaction chamber 112.

The example system 100 includes an air source 101 (e.g., ambient air and/or other air source), a fuel source 102, a compressor 104, a turbine 106, a heat exchanger 108, and a reaction chamber 112. As shown in FIG. 1, the example system may also include a generator 110 (the combination of the turbine 106 and generator 110 being a turbine generator) and a supplemental fuel source 114. In the example system 100 shown, a shaft 105 mechanically couples the turbine 106 to the compressor 104 and the generator 110. A gas turbine system may include additional, fewer, and/or different components, which may be used in the same and/or a different manner.

The example fuel source 102 provides fuel to the system 100 for sustaining an oxidation process in the reaction chamber 112. The example system 100 can utilize fuel that is initially gaseous and/or the system 100 can utilize liquid or solid fuels that can be converted into gas or vapor. The fuel source 102 may provide a single type of fuel and/or multiple different types of fuel one or all of which may be oxidized in the same reaction chamber. The fuel source 102 may provide hydrocarbon fuel and/or other types of fuel. The fuel source 102 may provide weak fuel. Weak fuels may include low BTU gases (i.e., low energy per unit mass) and/or fuels having low calorific value. Weak fuels may include gases containing fuels below a concentration that can sustain an open flame and/or other combustion reaction. In some instances, introducing a weak fuel to a spark or flame, even in the presence of air, may snuff out the spark or flame. However, when the weak fuel is raised to a temperature above its auto-ignition temperature, the fuel can oxidize in the presence of air without introduction of a spark or flame. A specific example of weak fuels include gas that is mostly carbon dioxide or nitrogen, containing small quantities of methane, ethane, carbon monoxide, and other types of fuel. Such gas is often emitted from so-called unproductive natural gas wells. The fuel source 102 may provide fuels other than, or in addition to, weak fuels. For example, in some implementations, the fuel source 102 may provide propane, butane, kerosene, gasoline, and/or other types of fuels in addition to, or instead of, weak fuels. In some cases, the fuel source 102 may provide hydrogen fuel.

The fuel source 102 may include gas emanated from a landfill, which may contain only a small percentage of methane fuel (e.g., 3 percent). A gas having such a low concentration of methane may be below a sustainable combustion threshold concentration, and therefore, the fuel may be too weak to sustain combustion. The fuel 102 can be a natural (e.g., non-anthropological) fuel source or a human-made (e.g., anthropological) fuel source. For example, the fuel source 102 may include methane from cattle belches, a swampland, a rice farm, and/or methane produced by fermentation of organic matter. Other example fuel sources can include manure, municipal waste, wetlands, gas seeping from leaks in the system or other systems, and drilling and recovery operations. In some implementations, the fuel source 102 includes a gasifier that generates gaseous fuel from solids. In some implementations, the fuel source 102 includes fuel mixed with water, and fuel from the fuel source 102 includes water vapor.

The supplemental fuel source 114 may also be utilized by the system 100. The example supplemental fuel source 114 may provide high BTU fuels (e.g., higher than the BTU of fuel source 102) and/or gases containing a concentration of fuel that can sustain a flame and/or combustion in the presence of a heat source. For example, the supplemental fuel source 114 may supply kerosene, gasoline, butane, propane, and/or others. The supplemental fuel source 114 may additionally or alternatively provide weak fuel as described above. For example, the supplemental fuel source 114 may receive fuel from the fuel source 102.

The supplemental fuel source 114 may be used as a pilot fuel for a startup process, for example, to heat the reaction chamber to an operating temperature. Fuel from the supplemental fuel source 114 may be used to supplement the fuel source 102 during operation of the system 100, for example, to raise a temperature in the reaction chamber 112. In some implementations, the system 100 can heat the reaction chamber 112 to operating temperatures and sustain operation using only weak fuels, independent of combustible fuels. As such, operation of the system 100 may not require fuel from the supplemental fuel source 114.

The example air source 101 provides air for the oxidation process in the reaction chamber 112. Hydrocarbon fuels are oxidized when they are heated above their auto-ignition temperature in the presence of oxygen. The air source 101 provides gas containing oxygen, which is mixed with the fuel from the fuel source 102 and/or fuel from the supplemental fuel source 114 prior to oxidizing the fuel. The air source 101 can provide air from the atmosphere surrounding the system 100. The air source 101 can provide air from a tank or cylinder of compressed or non-compressed air. Air from the air source 101 may contain oxygen at any concentration sufficient for the oxidation of the fuel. Air from the air source 101 may include other gases in addition to oxygen gas. For example, the air may include nitrogen, argon, and/or other reactive or non-reactive gases.

Air from the air source 101 may be mixed with fuel from the fuel source 102, and the resulting air/fuel mixture may be communicated to the compressor 104 and/or directly into the reaction chamber 112. The system may additionally include a mixer (not shown) that can mix the air and fuel. The air/fuel mixture may be a homogeneous mixture, where the fuel is uniformly distributed through the mixture, or the air/fuel mixture may be a non-homogeneous mixture. The air may be mixed with the fuel without using a mixer device. For example, the air/fuel mixture may be formed in a conduit by injecting the fuel into a stream of air. In some examples, the air and fuel may be mixed at additional and/or different points in the system 100. For example, air from the air source 101 may be combined with the fuel between the compressor 104 and the reaction chamber 112 before or after the fuel is pre-heated by the heat exchanger 108. As another example, air from the air source 101 may be combined with the fuel upon entering the reaction chamber 112. In some instances, the reaction chamber 112 may include an air inlet that introduces air from the air source 101 directly into the reaction chamber 112. In some implementations, the air may be introduced into the reaction chamber 112 as a control flow, for example, to cool regions of high temperature in the reaction chamber 112.

The example compressor 104 receives the air/fuel mixture, mixed by a gas mixer, through a compressor inlet, compresses the air/fuel mixture between the compressor inlet and a compressor outlet, and communicates the compressed air/fuel mixture through the compressor outlet. Notably, it is known that mixtures of air and fuel in certain concentrations, especially when pressurized, can be explosive. For fuels that are already very weak, this is not a concern. If the incoming fuel is a rich fuel, it must be diluted with air such that it is well below the threshold of explosiveness. However, because fuel and air are mixed prior to compression in the present system, this is relatively easy to accomplish. Furthermore, the concentration of fuel needed to achieve the temperatures of operation of all modern turbines is already well below the explosive threshold, thus safe operation and practical operation go hand in hand in the present system. The compressor 104 may receive mechanical rotational energy from the turbine 106 through the shaft 105. The compressor 104 can utilize the mechanical rotational energy from the turbine 106 to increase the pressure of the air/fuel mixture. In some implementations, the system 100 may include a compressor that operates in a different manner.

The example shaft 105 transfers rotational energy from the turbine 106 to the compressor 104 and the generator 110. In some implementations, the shaft 105 may include multiple shafts. For example, a first shaft may transfer energy from the turbine 106 to the compressor 104, and a second shaft may transfer energy from the turbine to the generator 110.

The heat exchanger 108 can pre-heat the air/fuel mixture. The example heat exchanger 108 receives the compressed air/fuel mixture from the compressor 104, pre-heats the compressed air/fuel mixture, and communicates the heated, compressed air/fuel mixture to the reaction chamber 112. The heat exchanger 108 may also receive exhaust gas from the turbine 106. The heat exchanger 108 may use heat from the exhaust gas to pre-heat the compressed air/fuel mixture. For example, the exhaust gas and the air/fuel mixture may contact opposite sides of a heat-transfer structure while flowing through the heat exchanger 108. The heat-transfer structure may conduct thermal energy from the higher temperature exhaust gas to the lower temperature air/fuel mixture. In some implementations, the system 100 may include a heat exchanger that operates in a different manner. For example, the system 100 may pre-heat the air/fuel mixture using heat from a different source, or the system 100 may communicate the air/fuel mixture into the reaction chamber 112 without pre-heating the mixture.

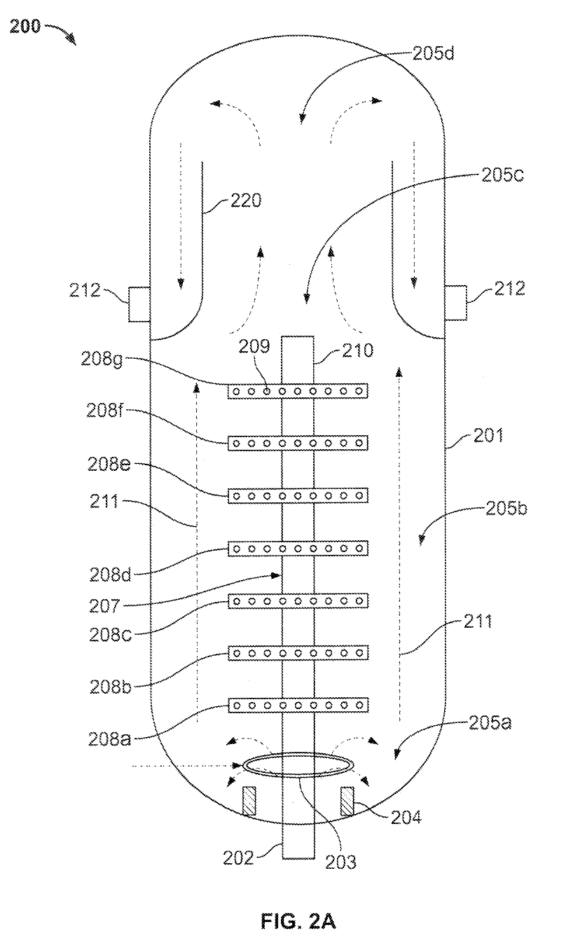

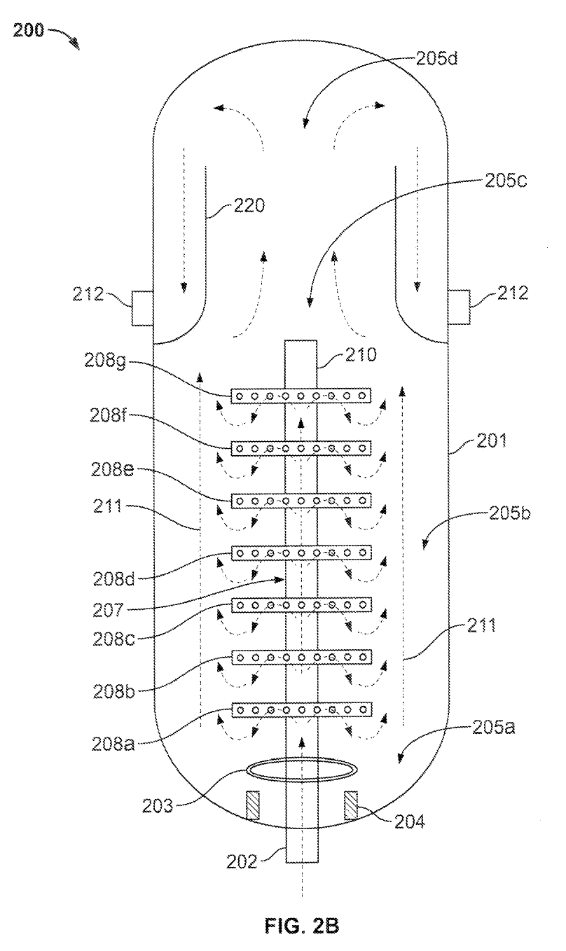

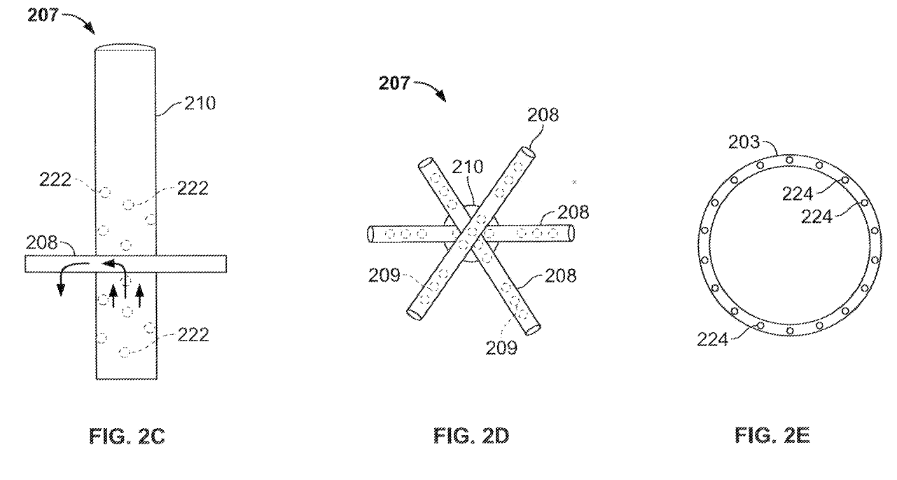

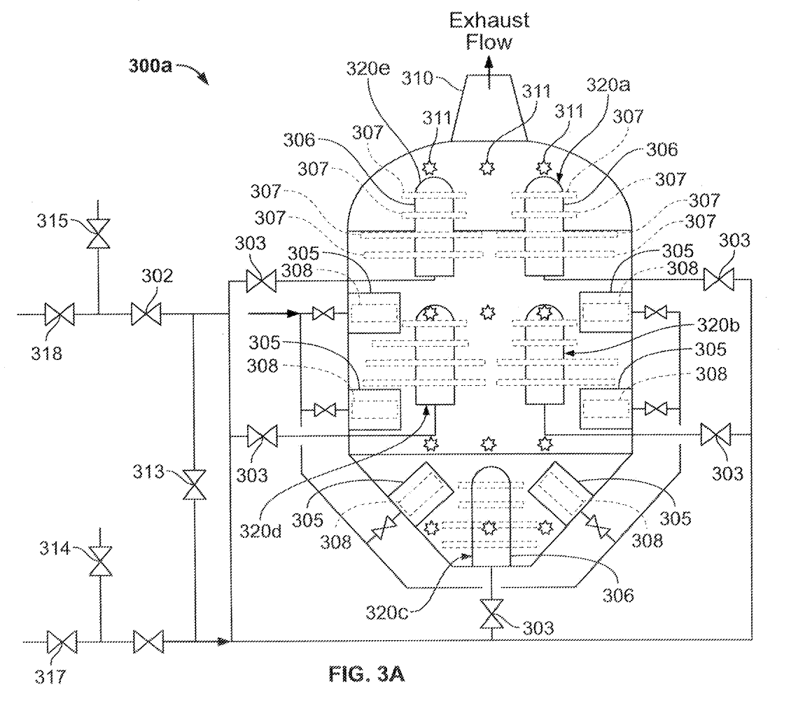

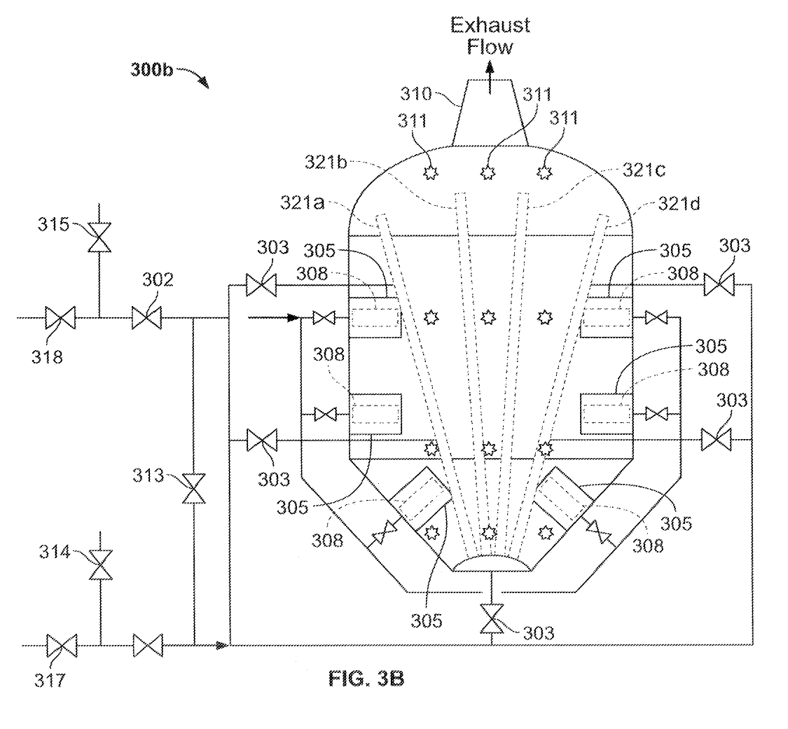

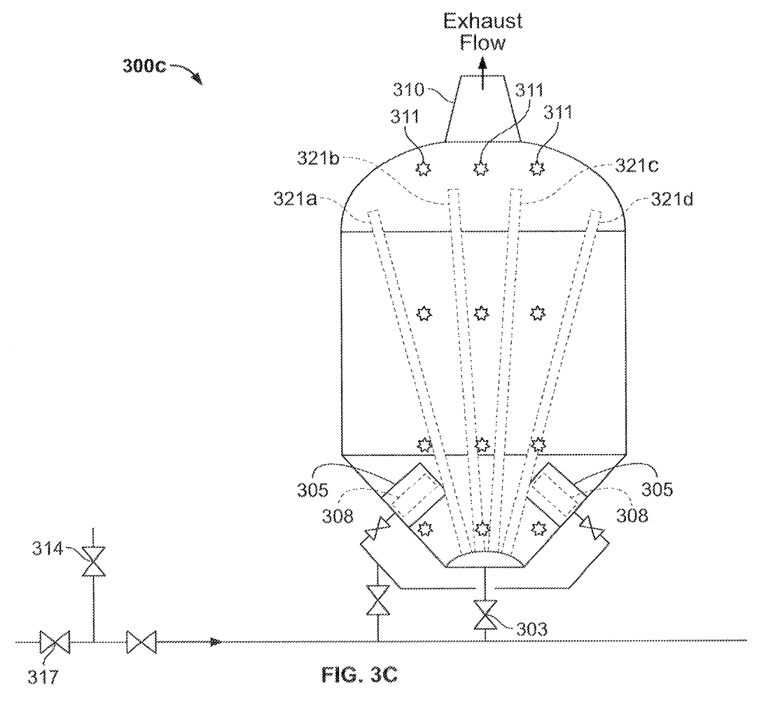

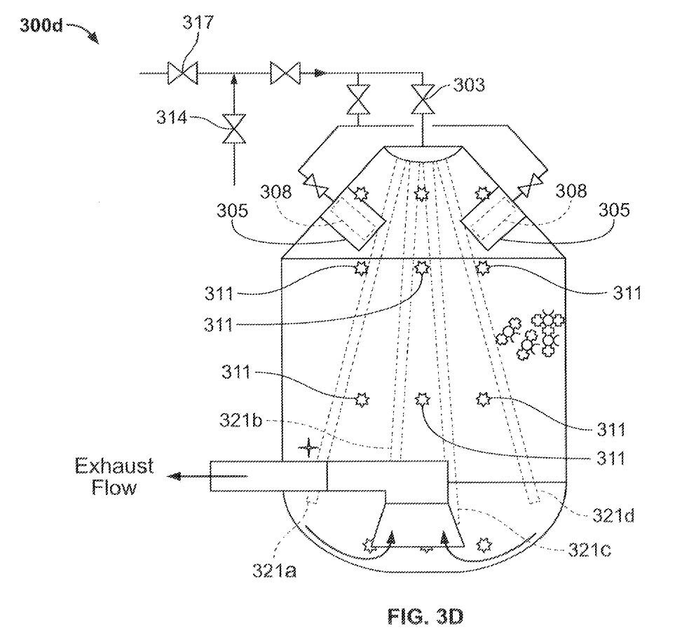

The reaction chamber 112 retains the air/fuel mixture as the fuel from the fuel source 102 oxidizes. Example reaction chambers are shown in FIGS. 2A, 2B, 3A, 3B and 3C. The reaction chamber 112 may include the same, different and/or additional features. Oxidation of the fuel in the reaction chamber 112 is initiated by raising the fuel to or above an auto-ignition temperature of the fuel. The system 100 may initiate oxidation in the reaction chamber 112 independent of oxidation catalyst materials (e.g., platinum) and/or independent of an ignition source (e.g., a flame or spark). Fuel may be oxidized in the reaction chamber 112 without raising the temperature of the air/fuel mixture above a threshold temperature, for example, by maintaining the maximum temperature of the fuel in the reaction chamber below the threshold temperature. The threshold temperature may be determined based on one or more factors, for example, the threshold temperature can be a recommended or maximum operating temperature of the turbine, a recommended or maximum inlet temperature for the turbine, a temperature that causes formation of nitrogen oxides, the flow rate of the fuel through the reaction chamber 112, and/or other factors. In some implementations, the threshold temperature can be below the lowest or the highest of a recommended or maximum operating temperature of the turbine, a recommended or maximum inlet temperature for the turbine, a temperature that causes formation of nitrogen oxides, the flow rate of the fuel through the reaction chamber 112, and/or other factors. In some implementations, fuel is oxidized in the reaction chamber 112 below a temperature that causes formation of nitrogen oxides. As such, the reaction chamber 112 can oxidize virtually all of the fuel while producing only minimal amounts of nitrogen oxides. For example, exhaust gas from the system 100 may include less than one part per million each of nitrogen oxide, VOCs and CO, and may even reduce the concentrations of VOCs and CO contained in the incoming air.

The reaction chamber 112 may include an internal volume lined with insulating refractory material. High temperature heat-absorbing and/or heat-resistant material, such as ceramic or rock, called fill material, may be provided in the reaction chamber 112. The fill material may have a thermal mass that facilitates slow oxidation of weak fuels flowing through the reaction chamber 112. The thermal mass may help stabilize temperatures for gradual oxidation of the fuel by transmitting heat to the incoming gases and receiving heat from the oxidized gases. In some cases, the thermal mass of refractory materials in the reaction chamber 112 may act as a dampener, absorbing heat and preventing excessive temperatures that could damage the turbine and/or produce unwanted byproducts (e.g., nitrogen oxides, carbon dioxides, volatile organic compounds and/or others). In some cases, the thermal mass of the refractory materials in the reaction chamber 112 may provide a temporary source of heat energy, which may help sustain oxidation of the fuel.

The volume and shape of the reaction chamber 112, and the configuration of the overall system, can be designed to provide a controlled flow and flow rate through the chamber, allowing sufficient dwell time for complete fuel oxidation. The flow path can be sufficiently long that a flow rate of the air and fuel mixture along the flow path, averaged over the length of the flow path, allows the fuel to oxidize to completion. As an example, the average dwell time of the gas in the chamber can be greater than one second in some cases. The average dwell time of the gas in the chamber can be less than one second in some cases. The rate of oxidation of the mixture is a function of the constituents of the fuel, fuel concentration, oxygen concentration, pressure, temperature and other factors. Thus, the dwell time can be adjusted by adjusting these parameters accordingly. The reaction chamber 112 may also include one or more sensors for detecting properties such as temperature, pressure, flow rate, or other properties relevant to the startup and/or operation of the gas turbine system 100. The reaction chamber 112 may also include internal structures and/or devices that control aspects of the oxidation process. For example, the reaction chamber 112 may include flow diverters, valves, and/or other features that control temperature, pressure, flow rate, and/or other aspects of fluids in the reaction chamber.

Generally, the reaction chamber 112 may have any geometry and/or orientation, and may include reaction chamber inlets and reaction chamber outlets at any set of locations. Moreover, the reaction chamber may define a primary direction of fuel flow through the reaction chamber (e.g., from one or more air/fuel inlet locations to an outlet from the reaction chamber). For example, fuel may flow through a reaction chamber primarily in an upward direction, primarily in a downward direction, primarily in any intermediate direction, and/or primarily at any angle. (Here, unless otherwise indicated, directions are indicated with respect to the direction of gravity. For example, “downward” indicates a direction parallel to gravity, and “upward” indicates a direction opposite of gravity.) The primary direction of flow may be defined by one or more aspects of the reaction chamber structure. For example, the reaction chamber inlets, the reaction chamber outlets, internal flow diverters and baffles, the internal geometry of the reaction chamber, and/or other aspects of the reaction chamber may define the primary direction of fuel flow through the reaction chamber. The example reaction chambers shown in FIGS. 1, 2A, 2B, 3A, 3B, and 3C have an internal geometry with a reaction chamber outlet near an upper end of the reaction chamber. As such, in the examples shown, fuel flows through the reaction chambers primarily in an upward direction. Notably, within the primary direction of flow through the reaction chamber, there may be non-primary flows such as localized swirls, eddies, slipstreams and otherwise.

The gas distributor system 116 distributes the inflow of the air/fuel mixture into the reaction chamber. Aspects of an example gas distributor system 207 are shown in FIGS. 2A-2D. Aspects of another example gas distributor system are shown in FIGS. 3A, 3B, 3C and 3D. The reaction chamber 112 may include a gas distributor system with the same, different, and/or additional features. The gas distributor system 116 is disposed within the interior of the reaction chamber. The gas distributor system 116 communicates the air/fuel mixture from one or more reaction chamber inlets to intended locations in the interior of the reaction chamber 112. For example, the distributor system 116 may include one or more inlet ports along the primary direction of flow through the reaction chamber 112. As such, the distributor system 116 can communicate the air/fuel mixture from the reaction chamber inlet to multiple locations distributed along a flow path through the interior of the reaction chamber. In certain instances, the inlet ports can be arranged to distribute the air/fuel mixture substantially throughout the interior of the reaction chamber.

In general, the better dispersed the air/fuel mixture through the reaction chamber, the better the likelihood of full oxidation of the fuel. The air/fuel mixture must typically be heated for the fuel to be oxidized, drawing heat from the reaction chamber. Oxidation of the fuel increases the gas temperature within the reaction chamber and in turn imparts heat to the reaction chamber; thus, promoting heating of the air/fuel mixture and oxidizing of the fuel. Increased dispersion of the mixture helps keep local temperatures in the reaction chamber within desired ranges. In certain instances, the gas distributor system 116 (including those disclosed with respect to reaction chambers 200 and 300a-300d discussed below) can distribute the air/fuel mixture such that heat released by oxidization of the fuel in the air/fuel mixture maintains a temperature substantially throughout the reaction chamber at a temperature sufficient to oxidize the fuel in the air/fuel mixture, and in certain instances, below a temperature that causes formation of nitrogen oxides. In certain instances, the gas distributor 116 (including those disclosed with respect to reaction chambers 200 and 300a-300d discussed below) can distribute the air/fuel mixture such that oxidization of the fuel in the air/fuel mixture maintains a temperature throughout 90% or more of the internal volume of the reaction chamber at a temperature sufficient to oxidize the fuel in the air/fuel mixture, and in certain instances, below a temperature that causes formation of nitrogen oxides.

The reaction chamber 112 may include one or more oxidation zones where air/fuel mixture is oxidized in the reaction chamber 112. The gas distributor system 116 may include a gas distributor structure for each oxidation zone. For example, when the reaction chamber 112 includes a single oxidation zone, as the example reaction chamber 200 of FIGS. 2A and 2B, the distribution system 116 can include a distributor that extends through the oxidation zone and communicates the air/fuel mixture into the oxidation zone at multiple discrete and spaced-apart locations along a primary flow path through the oxidation zone. As another example, when the reaction chamber 112 includes multiple oxidation zones, as the example reaction chamber 300a of FIG. 3A, the distribution system 116 can include multiple distributors that each extend through one of the oxidation zones. Each distributor can communicate the air/fuel/mixture into its respective oxidation zone at multiple spaced-apart locations along a primary flow path through the zone. In some implementations, one or more of the oxidation zones is downstream from another oxidation zone in the flow path through the reaction chamber. Similarly, in some implementations, one or more of the oxidation zones is upstream from another oxidation zone in the flow path through the reaction chamber. In some implementations, the oxidation zones parallel through the reaction chamber in the direction of the primary flow path.

The distribution system 116 includes one or more conduits that communicate the air/fuel mixture from the reaction chamber inlet(s) through the gas distribution system 116. The distribution system 116 includes multiple ports that communicate the air/fuel mixture from the conduits of the gas distribution system into the oxidation zone(s) in the reaction chamber. The reaction chamber 112 heats the air/fuel mixture and oxidizes the fuel in the oxidation zone(s). The fuel, which may be mixed with air, oxidized fuel, and/or other components, flows along the primary direction of flow through at least a portion of the reaction chamber toward the reaction chamber outlet(s).

The distribution system 116 may include one or more separate structures for communicating fuel from the supplemental fuel source 114 into the reaction chamber. For example, the reaction chamber may include a separate gas distributor in each oxidation zone for communicating fuel from the supplemental fuel source 114 into an oxidation zone. Fuel from the supplemental fuel source 114 may be communicated into an oxidation zone by supplemental gas distributor, such as the ring shaped supplemental gas distributor 203 of FIGS. 2A, 2B, and 2E. Each supplemental gas distributor may communicate the fuel into an oxidation zone at a single location on the primary flow path through the reaction chamber 112.

The reaction chamber 112 includes one or more outlets that communicate oxidized fuel and/or other materials to the turbine 106. The gas exiting the reaction chamber 112 through the outlets may include completely oxidized fuel, non-reactive gases, and only trace amounts of nitrogen oxides and carbon dioxide. In some instances, the gas exiting the reaction chamber 112 through the outlets may include more than trace amounts of unoxidized fuel, nitrogen oxides, carbon dioxide, and/or other materials. The gas exiting the reaction chamber 112 may be in a range of recommended inlet temperatures for the turbine 106. In some cases, gas exiting the reaction chamber may be at or above a maximum inlet temperature of the turbine 106.

The turbine 106 converts energy of the oxidation product gas to rotational mechanical energy. The example turbine 106 receives the oxidized fuel through a turbine inlet, expands the oxidized fuel between the turbine inlet and a turbine outlet, and communicates the expanded gas through the turbine outlet. The turbine 106 may transmit mechanical rotational energy to the compressor 104 through the shaft 105. The turbine 106 may transmit mechanical rotational energy to the generator 110 through the shaft 105. In some implementations, the system 100 may include a turbine that operates in a different manner.

The generator 110 converts rotational energy from the turbine 106 to electrical energy. For example, the generator 110 can output electrical power to a power grid or to a system that operates on electrical power. In some implementations, the generator 110 may provide mechanical energy to the compressor 104 during startup. For example, the generator may be capable of operating in a motoring mode that converts electrical power to mechanical energy. In some instances, the system 100 may operate without providing energy to the generator 110. For example, the system 100 may operate as a thermal oxidizer to destroy fuel and/or other materials independent of outputting power.

In some aspects of operation of the example system 100, the fuel source 102 supplies fuel and the air source 101 provides air to form an air/fuel mixture. The air/fuel mixture is communicated into the compressor 104. The compressor 104 compresses the air/fuel mixture and communicates the compressed air/fuel mixture to the heat exchanger 108. The heat exchanger 108 heats the compressed air/fuel mixture and communicates the heated mixture to an inlet of the reaction chamber. The gas distribution system 116 communicates the air/fuel mixture from the reaction chamber inlet to multiple locations within the reaction chamber 112. The air/fuel mixture exits the gas distribution system 116 at multiple locations along a primary flow path through the reaction chamber 112. The fuel is heated and oxidized in the reaction chamber 112. Output gas, which includes the oxidation product gas, is communicated through the reaction chamber 112 to a reaction chamber outlet to the turbine 106. The oxidation product gas drives the turbine 106, and the turbine 106 communicates the oxidation product gas to the heat exchanger 108. The oxidation product gas provides heat energy to the heat exchanger 108 and exits the system, for example, through an exhaust stack. The oxidation product gas may be cooled with gas (e.g., air and/or another gas or liquid) applied to the oxidation product prior to the turbine via valve in line 122. In certain instances, the oxidation product gas may be cooled to prevent overheating the turbine.

Fluid communication through the system 100, for example between the components shown in FIG. 1, may be measured by sensors and/or monitoring devices, may be controlled and/or regulated by control valves and other types of flow control devices, and/or may be contained by conduits, pipes, ports, chambers, and/or other types of structures. As such, the system 100 may include additional devices, structures, subsystems not specifically shown in FIG. 1. The reaction chamber 112 may be operated at, above or below atmospheric and/or the ambient pressure around the exterior of the chamber 112. In some implementations, the reaction chamber 112 may be operated at, above, or below a pressure of 0.1 kilogram per square centimeter (kg/cm²). The reaction chamber 112 may be started up at low pressures after which pressures may be raised as desired. Control subsystems may be tuned to adjust to flow, viscosity and other changes that accompany pressure changes. Similarly, the reaction chamber 112 could be shut down by first depressurizing in a stable manner followed by flow and other curtailments.

FIGS. 2A and 2B are diagrams of an example reaction chamber 200. For example, the reaction chamber 200 can be used as the reaction chamber 112 of FIG. 1. As above, the reaction chamber 200 is defined by the interior perimeter of a vessel. FIG. 2A shows the reaction chamber 200 operating in an heat-up mode, where fuel flows into a lower end of the reaction chamber 200 through an supplemental gas distributor 203. FIG. 2B shows the reaction chamber 200 operating in a sustained oxidation mode, where a gas distribution system 207 in the reaction chamber 200 distributes fuel into the reaction chamber 200 at multiple locations along a fuel flow path through the reaction chamber 200. The reaction chamber 200 may operate in additional and/or different modes of operation. For example, the reaction chamber 200 may also operate in a heat-up mode, a sustained oxidation mode, and/or a transient mode that utilizes fuel flow through both the supplemental gas distributor 203 and the gas distribution system 207. These and other modes of operation may include fuel flows from additional and/or different sources.

The example reaction chamber 200 includes an outer housing 214 that defines an elongate outer structure of the reaction chamber 200. The reaction chamber 200 may include an inner or outer insulating lining 201. The lining 201 may include high temperature resistant materials such as ceramic, rock, fiberglass and/or other types of materials. The inner volume of the reaction chamber may be filled partly or substantially with high temperature resistant ceramic or other fill material that may be in graded sizes and shapes, which may included uniform or non-uniform sizes and shapes. The fill material may be homogeneous or porous, with desired heat absorption, retention and release properties. The example reaction chamber 200 may be provided without a catalyst.

Multiple regions 205a, 205b, 205c, and 205d inside the inner volume of the reaction chamber 200 are labeled in FIGS. 2A and 2B for purposes of discussion. A first region 205a is a volume surrounding the supplemental gas distributor 203 at the lower end of the reaction chamber 200. A second region 205b is a volume surrounding the gas distributor system 207. A third region 205c is a volume within the inner radius of the baffle 220 near the upper end of the reaction chamber 200. A fourth region 205d is a volume at the upper end of the reaction chamber 200.

The reaction chamber 200 includes a reaction chamber inlet 202 that communicates input gas into the gas distributor system 207 in the interior of the reaction chamber 200. The reaction chamber 200 includes multiple reaction chamber outlets 212 that communicate output gas from the interior of the reaction chamber 200. The reaction chamber inlet 202 is located near a lower end of the reaction chamber 200, and the reaction chamber outlets 212 are located near an upper end of the reaction chamber 200. The reaction chamber 200 may include fewer or additional inlets and/or fewer or additional outlets in additional and/or different locations.

The example reaction chamber 200 includes a gas distributor system 207 within the interior of the reaction chamber 200. The gas distributor system 207 is an elongate structure that extends from the lower end of the reaction chamber 200 toward the upper end of the reaction chamber 200. In the example shown in FIGS. 2A and 2B, the gas distribution system 207 extends through the center of the reaction chamber 200 in an axial direction. In some implementations, the gas distributor system 207 may extend the full length of the interior of the reaction chamber 200, although in the example shown it does not. The gas distributor system 207 distributes fuel into an oxidation zone where fuel is oxidized in the reaction chamber 200. The oxidation zone surrounding the gas distributor system 207 includes the region 205b.

The interior volume of the reaction chamber 200 along with the baffles 220 and the outlets 212 define a primary direction of fuel flow through the reaction chamber. Fuel flows from the gas distributor system 207 through the reaction chamber 200 generally toward the reaction chamber outlets 212. Fuel that is part of the air/fuel mixture in the gas distributor system 207 is oxidized in the oxidation zone around the gas distributor system 207, for example in the region 205b. Gas flow through the oxidation zone is shown by the arrows 211. The gas flowing through and from the oxidation zone may include at a given point a combination of oxidation product gases, unoxidized fuel, air, non-reactive gases, and/or other constituents. From the oxidation zone, the gas flows toward the region 205c near upper end of the reaction chamber 200. The baffles 220 guide gas flow from the gas distributor system 207 in an axial direction toward the region 205d at the upper end of the reaction chamber 200 within the inner radius. The baffles 220 and the inner surface of the reaction chamber 200 guide fuel flow in the upper end of the reaction chamber 200 to the outlets.

The gas distributor system 207 includes a sparger 210 in fluid communication with the reaction chamber inlet 202. The sparger 210 carries multiple gas distribution arms 208a, 208b, 208c, 208d, 208e, 208f, and 208g (collectively, “arms 208”) extending from the sparger 210. The sparger 210 is in fluid communication with each of the arms 208. The arms 208 each define multiple ports 209 that provide fluid communication into the oxidation zone surrounding the gas distributor system 207.

FIGS. 2A-2D show one example geometry and structure of a gas distributor system. FIGS. 3A-3C show additional example geometries and structures of a gas distributor system. The geometry and/or structure of the example gas distributor systems shown in the figures may be modified in a variety of ways. The gas distributor system 207 may include fewer or additional arms 208 in the same or a different configuration. Generally, the arms 208 may extend at any angle and azimuth from the sparger 210, or at any combination of angles and azimuths; the arms 208 may have any radial length or combination of radial lengths or other distribution pathways accommodated by the geometry of the interior of the reaction chamber 200. The arms 208 may be evenly distributed along an axial length of the sparger 210, or the arms may be unevenly spaced apart. In some implementations, one or more of the arms 208 may be omitted. The sparger 210 may include ports that provide fluid communication from the interior of the sparger 210 directly into the oxidation zone surrounding the gas distributor system 207. The arms 208 may have any cross-sectional geometry, such as circular, square, triangular, or another geometry. The arms 208 may define fewer or additional ports 209. The ports 209 may be evenly distributed and/or irregularly spaced-apart along longitudinal axis of the arms 208. The ports 209 may all have the same radial orientation, or the ports 209 may have any combination radial orientations with respect to the longitudinal axis of the arms 208, or other pathways intended to control distribution.

Features of the example gas distribution system 207 are shown in FIGS. 2C and 2D. FIG. 2C shows a side view of the gas distribution system 207 with only one arm 208. FIG. 2D shows a top view of the gas distribution system 207 with multiple arms 208. As shown in FIG. 2C, the sparger 210 includes ports 222 distributed around the circumference of the sparger 210 and distributed along the longitudinal length of the sparger 210. Each of the ports 222 has a radially opposite port 222 on the other side of the sparger 210. Each of the arms 208 is carried in a pair of opposing ports 222. Only one gas distribution arm 208 is shown in FIG. 2C. Typically a gas distribution arm 208 is carried in each pair of ports 222 of the sparger. As shown in FIG. 2D, the gas distribution arms 208 extend through the example sparger 210 at three different azimuthal angles. Additional and/or different configurations may be used.

Fuel flows from the reaction chamber inlet 202 through the gas distribution system 207 into the oxidation zone. The sparger 210 receives the fuel through the reaction chamber inlet 202 from an external source. The gas distribution system 207 may receive fuel from a fuel source such as the fuel source 102 of FIG. 1 and/or from a supplemental fuel source such as the supplemental fuel source 114 of FIG. 1. The fuel may be included in a compressed and/or pre-heated air/fuel mixture. For example, the air/fuel mixture may be received from a compressor or a heat exchanger. In the example shown in FIGS. 2A and 2B, the sparger 210 communicates the fuel in an axial direction parallel to the primary direction of fuel flow. The sparger 210 communicates the fuel through the ports 222 of the sparger 210 into the arms 208. As the fuel flows through the sparger 210, the velocity of the fuel flow through the sparger 210 may decrease due to portions of the fuel flowing out of the sparger 210 into the arms 208. In the example shown, the arms 208 communicate the fuel radially away from the sparger 210. The arms 208 communicate the fuel through the ports 209 into the oxidation zone.

The fuel enters the oxidation zone through the ports 209 at multiple different locations. For example, each of the arms 208 communicate fuel into the oxidation zone at different location along the primary flow path shown by the arrow 211. The ports 209 in the arm 208a distribute fuel into the oxidation zone at a first location along the primary flow path; the ports 209 in the arm 208b distribute fuel into the oxidation zone at a second location along the primary flow path; the ports 209 in the arm 208c distribute fuel into the oxidation zone at a third location along the primary flow path, and so forth. This gas distribution technique may allow more complete, gradual oxidation of fuel in the oxidation zone. The fuel may be fully oxidized in the oxidation zone surrounding the gas distribution system 207. In some cases, the majority of the fuel is oxidized in the oxidation zone, and the oxidation process may continue as the fuel flows through other regions of the reaction chamber 200.

The supplemental gas distributor 203 communicates fuel into the region 205a at the lower end of the reaction chamber 200. The supplemental gas distributor, shown as ring 203, may receive fuel from a fuel source such as the fuel source 102 of FIG. 1 and/or from a supplemental fuel source such as the supplemental fuel source 114 of FIG. 1. Whereas the gas distributor system 207 distributes fuel at multiple locations along a fuel flow path in the reaction chamber, the supplemental gas distributor 203 may communicate fuel into a localized volume in the reaction chamber 200. For example, the supplemental gas distributor 203 may communicate pilot fuel into the region 205a during a reaction chamber heat-up mode of operation. Any other distribution shape other than a ring may also be used.

The reaction chamber includes a heater 204 that can be used to heat the fuel in the reaction chamber 200. The heater 204 may be used during the heat-up mode of operation, during a sustained oxidation mode of operation, and/or in other instances. The heater 204 can include an electric heating element, a gas heating element, and/or another type of heating element. The heater 204 may have any geometry accommodated by the reaction chamber 200. The example heater 204 shown in FIGS. 2A and 2B has an annular geometry. The annular electric heater 204 surrounds the supplemental gas distributor 203 and heats fuel as the fuel is communicated into the region 205a. Fuel from the supplemental gas distributor 203 may be oxidized in the region 205a around the supplemental gas distributor 203. Fuel, oxidation product, and/or other gases may flow from the region 205a to the oxidation zone surrounding the gas distributor system 207, and the gases may follow the same flow path through the reaction chamber as the fuel entering the reaction chamber through the gas distributor system 207.

Features of the example supplemental gas distributor 203 are shown in FIG. 2E. The supplemental gas distributor 203 includes multiple ports 224 distributed around a perimeter of the supplemental gas distributor 203. The supplemental gas distributor 203 may distribute fuel through the ports 224 into the reaction chamber 200 uniformly or non-uniformly around the perimeter of the supplemental gas distributor 203. The example supplemental gas distributor 203 shown in FIGS. 2A, 2B, and 2E has a circular geometry. Generally, an supplemental gas distributor may have any geometry that distributes fuel through multiple ports. For example, the supplemental gas distributor may be circular, square, oblong, irregularly shaped or use spokes instead of a closed ring shape; the supplemental gas distributor may include gas distribution arms and/or other structures.

In one aspect of operation, the reaction chamber 200 is heated during a startup process. An example of a heat-up mode of operation is shown in FIG. 2A. In ambient conditions, the interior volume of the reaction chamber 200 is initially too cool to sustain a continuous oxidation process, and the reaction chamber 200 has to be heated to a desired operating condition. Operating the reaction chamber 200 in a heat-up mode may bring the reaction chamber to an internal temperature (and/or pressure) that sustains a continuous oxidation process. Initially, the interior of the reaction chamber 200 may be at an ambient temperature, for example, less than 100 degrees Fahrenheit (° F.). The heater 204 is turned on. The heater 204 may deliver heat energy at a high temperature. For example, the heater 204 may achieve temperatures in the ranges of 1500° F., 2000° F., and/or higher temperatures.

With the heater 204 turned on, pilot fuel is communicated into the region 205a surrounding the heater 204 through the supplemental gas distributor 203. The heater 204 may heat the pilot fuel to or above an auto-ignition temperature of the pilot fuel. For example, the auto-ignition temperature of methane gas is approximately 1000° F., and the heater may heat incoming methane pilot fuel above 1000° F., for example to 1400° F. When the pilot fuel begins to oxidize in the reaction chamber, the heat energy released by the oxidation reaction heats the region 205a, which in turn heats the fill material in the reaction chamber surrounding the region 205a. The fill material has a high thermal mass and retains the heat energy. Temperatures in the reaction chamber 200 may be monitored by temperatures sensors throughout the reaction chamber 200.

Heat energy from the region 205a and the fill material surrounding the region 205a is transferred downstream in the reaction chamber 200 to the region 205b, for example by conduction and/or convection processes. As the region 205b begins to heat up, additional fuel may be communicated into the reaction chamber 200 through the gas distribution system 207. The fuel may initially be communicated into the reaction chamber 200 through the gas distribution system 207 at a slow flow rate while the region 205b continues heating. The flow rate may be gradually increased until the interior of the reaction chamber 200 achieves a desired operating temperature. For example, the desired operating temperature of the reaction chamber 200 may be a recommended or maximum inlet temperature of a turbine in fluid communication with the outlets 212. The desired operating temperature may be lower than a temperature that causes formation of nitrogen oxides. In an example implementation, the desired operating temperature is between 1600° F. and 1700° F.

After the reaction chamber 200 has achieved a desired operating temperature and/or a desired operating temperature profile, the reaction chamber 200 may sustain a continuous oxidation process. An example of a sustained oxidation mode of operation is shown in FIG. 2B. As shown in FIG. 2B, the example gas distribution system 207 extending through the oxidation zone in the reaction chamber 200 communicates fuel into the oxidation zone at multiple locations along the fuel flow path. The fuel flows through the reaction chamber inlet 202, through the sparger 210, through the ports 222, through the arms 208, and through the ports 209 into the oxidation zone. The fuel is oxidized in the oxidation zone and communicated through the reaction chamber in the primary direction of fuel flow through the reaction chamber, as indicated by the arrows 211. Some flow patterns and flow transients having different flow directions may exist in various local regions within the reaction chamber 200. For example, the arms 208, near the fill material, and/or in other local regions in the reaction chamber 200 may divert local flow from the primary direction of fuel flow. Despite the presence of such local flow transients and diversions, the bulk flow of fluid through the reaction chamber is in the primary direction of fuel flow, as defined by the relationship among the fuel inlet ports, the reaction chamber outlets 212, the internal structure of the reaction chamber 200, and/or the geometry of the inner volume of the reaction chamber 200.

During the sustained oxidation process, the temperature and/or pressure profile of fluids in the reaction chamber 200 may be substantially uniform throughout the inner volume of the reaction chamber 200. In some instances, there may be temperature and/or pressure differences between one or more regions inside the reaction chamber 200. In some instances, there may be temperature and/or pressure gradients across one or more regions inside the reaction chamber 200.

FIG. 3A is a diagram of an example reaction chamber 300a. For example, the reaction chamber 300a can be used as the reaction chamber 112 of FIG. 1. The reaction chamber 300a may additionally or alternatively include features of the example reaction chamber 200 of FIGS. 2A and 2B. The reaction chamber 300a includes a gas distribution system having multiple gas distribution structures 320a, 320b, 320c, 320d, and 320e (collectively, “gas distribution structures 320”) that distribute fuel into different oxidation zones within the inner volume of the reaction chamber 300a. Each distribution structure 320 extends through an oxidation zone in the reaction chamber and communicates fuel into the oxidation zone at multiple locations along a primary direction of flow through the reaction chamber 300a. The primary direction of flow through the reaction chamber 300a is in the direction from the reaction chamber inlets at a first end of the reaction chamber 300a toward the reaction chamber outlet 310 at an opposing end of the reaction chamber 300a. A first gas distribution structure 320a is upstream from the other four distribution structures 320b, 320c, 320d, 320e. Two of the gas distribution structures 320d and 320e are downstream, and two of the gas distribution structures 320b and 320c are intermediate. The reaction chamber 300a may be modified to include fewer, additional, or the same number of gas distribution structures in a similar or different configuration.

Each of the gas distribution structures 320 can include a structure similar to the structure of the gas distribution system 207 of FIGS. 2A, 2B, 2C, and 2D; and each of the gas distribution structures 320 can function in a manner similar to the gas distribution system 207 of FIGS. 2A, 2B, 2C, and 2D. For example, each of the gas distribution structures 320 includes a sparger 306 that carries gas distribution arms 307. The sparger 306 and the distribution arms 307 may include features and characteristics shown and/or described with respect to the sparger 210 and the arms 208 of FIGS. 2A, 2B, 2C and 2D. Each of the gas distribution structures 320 has an associated heater 305 and an associated air/fuel dispersal tube 308. The heater 305 and the air/fuel dispersal tube 308 may be used to heat up sections of the reaction chamber zone at the same time or at different times during a heat-up mode of operation of the reaction chamber 300a. For example, the heaters 305 and air/fuel dispersal tube 308 may function similar to the heaters 204 and supplemental gas distributors 203 of FIGS. 2A, 2B, and 2E. A heat-up process may utilize fewer than all of the heaters 305 and tubes 308. One or more of the heaters 305 and one or more of the tubes 308 may be utilized during a sustained oxidation mode of operation.

In some aspects of operation, a mixture of fuel and air maintained below a threshold concentration of flammability or combustibility is introduced to the gas distribution structures 320 in the reaction chamber 300a through one or more pipes controlled by valves 303. The pipes supply the mixture to the spargers 306. Each sparger 306 distributes flow selectively into the reaction chamber 300a. Selective flow may be achieved through holes or slots defined in the spargers 306 and/or by additional distribution arms 307 that may also define holes or slots. Each heater 305 can be positioned near supplemental gas distributors 308 that can introduce an additional air/fuel mixture into a volume in reaction chamber 300a near the heater 305. A separate source of auxiliary fuel and air may be provided through valves 302. The main fuel introduced through the valves 303 has an air supply source through valve 314 that can maintain the air/fuel mixture at a desired concentration. The auxiliary fuel has an air supply source through valve 315 that maintains the air/fuel mixture at a desired concentration. Valve 317 controls the main fuel flow and valve 318 controls the auxiliary fuel flow. Valve 313 provides a cross tie between the two fuel sources.

Following oxidation of the fuel in the reaction chamber 300a, hot gases exit the reaction chamber 300a through the reaction chamber outlet 310. The reaction chamber 300a may be filled partially with ceramic or other fill material that will absorb, retain and impart heat to sustain the oxidation reaction. Temperature sensors 311 are located at desired locations in the reaction chamber 300a. Pressure sensors may also be placed at desired locations in the reaction chamber 300a.

During sustained operation, the fill material inside the vessel is at a temperature sufficiently above the temperature for the fuel in the air/fuel mixture to oxidize. The temperature can be controlled so that the temperature of oxidized gas exiting the reaction chamber 300a is at the desired temperature or range of temperatures for the intended application. Low temperatures in the reaction chamber 300a may slow down the oxidation process inside the reaction chamber 300a and lead to instability or incomplete oxidation if not regulated. Temperature stability may be achieved by a combination of controls. Fuel concentration can be controlled by manipulating valves 314 and 317 to provide a desired fuel concentration. If the temperature inside the reaction chamber 300a increases beyond a desired temperature range, the fuel flow, fuel concentration, or both can be reduced. If the temperatures inside the reaction chamber 300a decrease below a desired temperature range, the fuel flow into the vicinity to the temperature increase can be reduced using one or more of the valves 303. Each of the valves shown in FIG. 3A can be controlled independently. Another control option available is to modify the heat intensity of heaters 305 and/or supplemental gas distributors 308. The condition of the reaction chamber 300a may be monitored by temperature sensors 311. The fill material provides a thermal mass that helps to retard the rate of change, keeping temperatures from rising or falling too quickly, and thus helping to achieve stability inside the reaction chamber 300a.

The flow distribution from the spargers 306 and/or the arms 307 spreads the incoming air/fuel mixture over a wide area of fill material within the interior volume of the reaction chamber 300a. If instead, all entering fuel initially impacted only a small portion of the fill, the fill may tend to cool as it heats the fuel. Over time, this could render the ceramic too cool to promote oxidation, which may quench the sustained oxidation process.

During a heat-up mode, the fill material may be heated sufficiently to sustain the oxidation reaction. This may be achieved by first turning on one or more of the heaters 305 until a hot zone is created around the activated heaters 305. When the heaters 305 are sufficiently hot, a fuel and air mixture of desired concentration is introduced into the hot zone through spargers 308, and the flow rate is controlled to ensure that the entering gas is fully oxidized. Heat released by oxidation increases the size of the hot zone, which increases the quantity of gas that can now be oxidized by the hot zone. Thus, gas flow is gradually increased, and in time, the entire vessel including fill material inside the vessel is sufficiently hot. When the entire vessel is hot, the main gas mixture may now be introduced through valves 303 at a rate consistent with full oxidation of the gas. Heaters 305 and spargers 308 may be maintained in service continuously, or as needed. If hot spots develop inside the reaction chamber 300a, one or more ports may be provided at various locations along the sidewall of the reaction chamber 300a to inject nitrogen into the hot spot until it cools off. If cold spots develop inside the reaction chamber 300a, propane or other high energy fuel may be injected into the cold spot until it reheats. The same ports may be used for both nitrogen and propane. Any other inert gas or fuel such as carbon dioxide, natural gas, butane or liquid fuel may be used instead of nitrogen and propane. The control of hot or cold spots, as described, may be used occasionally to recover from transient conditions.

FIG. 3B is a diagram of another example reaction chamber 300b. For example, the reaction chamber 300b can be used as the reaction chamber 112 of FIG. 1. The reaction chamber 300b is a variation of the reaction chamber 300a of FIG. 3A. Whereas the reaction chamber 300a of FIG. 3A includes multiple gas distribution structures 320a, 320b, 320c, 320d, and 320e, the reaction chamber 300b includes a set of distribution tubes 321a, 321b, 321c, and 321d (collectively, tubes 321). The tubes 321 extend at varying angles from a longitudinal direction through the interior of the reaction chamber 300a. The tubes 321 include multiple ports along the longitudinal lengths of the tubes 321. The valves 303 may control the flow of fuel into the tubes 321 at multiple locations along the length of the tubes. The ports along the length of the tubes 321 distribute the fuel into an oxidation zone surrounding the tubes 321 at different locations along a primary flow direction through the reaction chamber 300b. As in the reaction chamber 300a, the primary direction of flow through the reaction chamber 300b is in the direction from the inlet to the outlet 310. Supplemental gas distributors 308, the heaters 305, and other aspects of the reaction chamber 300b may function as the supplemental gas distributors 308, the heaters 305, and similar aspects of the reaction chamber 300a.

FIG. 3C is a diagram of another example reaction chamber 300c. For example, the reaction chamber 300c can be used as the reaction chamber 112 of FIG. 1. The reaction chamber 300c is a variation of the reaction chamber 300b of FIG. 3B. Whereas the reaction chamber 300b of FIG. 3B includes multiple valves 303 that control the flow of fuel into the tubes 321 at multiple locations along the length of the tubes 321, the reaction chamber 300c of FIG. 3C only includes a single valve 303 that controls a flow of fuel into the tubes at a first end of the reaction chamber near the inlet. Also, the reaction chamber 300c only includes a heater 305 and a supplemental gas distributor 308 at a first end of the reaction chamber near the inlet. Other aspects of the reaction chamber 300c may function similar the reaction chamber 300b.

FIG. 3D is a diagram of another example reaction chamber 300d. For example, the reaction chamber 300c can be used as the reaction chamber 112 of FIG. 1. The reaction chamber 300d is a variation of the reaction chamber 300c of FIG. 3C, but inverted. As such, flow exits through an inverted outlet near the bottom of the chamber 300d. Other aspects of the reaction chamber 300d may function similar the reaction chamber 300c.

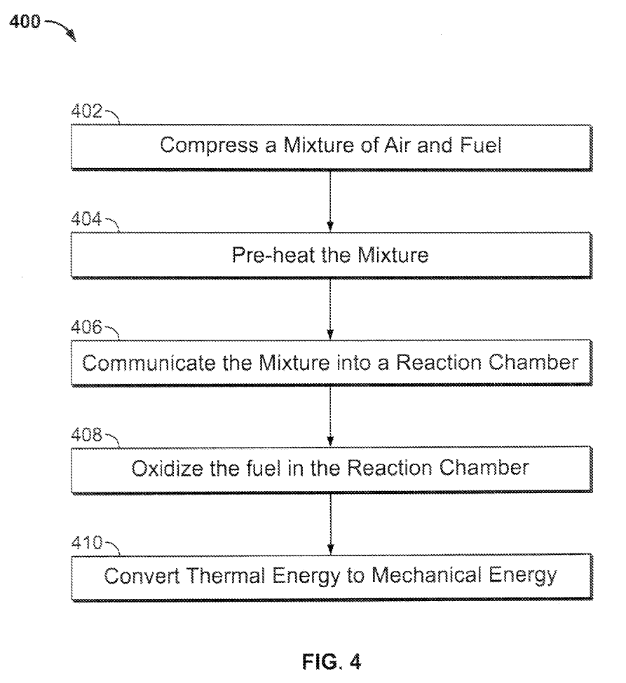

FIG. 4 is a flow chart of an example process 400 for oxidizing fuel. The process 400 can be used for oxidizing fuel in a gas turbine system, such as the gas turbine system 100 of FIG. 1. The process 400 may include additional, fewer, and/or different operations performed in the order shown in FIG. 4 or in a different order. Aspects of the process 400 may be adapted for oxidizing fuel in other types of systems. For example, aspects of the process 400 may be adapted for oxidizing fuel in a thermal oxidizer system that does not drive a turbine or provide energy conversion. Accordingly, individual operations and/or subsets of the operations of the example process 400 can be implemented in isolation and/or in other contexts for other purposes. Further, in some implementations, one or more of the operations of the process 400 may be omitted, repeated, performed in parallel with other operations, and/or performed by a separate system.

At 402, an air/fuel mixture is compressed. The air/fuel mixture can be compressed by a compressor, for example, the compressor 104 of FIG. 1. The air/fuel mixture can include air mixed with a hydrocarbon fuel. The air/fuel mixture may include one type of fuel, or the air/fuel mixture may include multiple different fuel constituents. The air/fuel mixture may have a low concentration of fuel. For example, the fuel concentration in air may be less than threshold concentrations where the air/fuel mixture would become combustible or explosive. The air/fuel mixture may be a homogeneous mixture in which the fuel is uniformly distributed in the air, or the mixture may be non-homogeneous. In some implementations, the air/fuel mixture is received from a mixer. In some implementations, the air/fuel mixture is formed by injecting the fuel into an air stream.

At 404, the air/fuel mixture is pre-heated. The compressed air/fuel mixture can be communicated from a compressor to a heat exchanger, for example, the heat exchanger 108 of FIG. 1. The heat exchanger may transfer heat energy from exhaust gas to the compressed air/fuel mixture. Pre-heating the air/fuel mixture increases the temperature of the mixture. The air/fuel mixture may be pre-heated to a temperature below the auto-ignition temperature of the fuel.

At 406, the air/fuel mixture is distributed into the reaction chamber. The air/fuel mixture may be distributed from a reaction chamber inlet into an oxidation zone in the reaction chamber through multiple ports into the oxidation zone. The air/fuel mixture may be introduced into the oxidation zone at multiple locations along a primary direction of fuel flow through the reaction chamber. In some implementations, fuel is distributed from multiple reaction chamber inlets into multiple oxidation zones in the reaction chamber. The fuel may be distributed into each of the oxidation zones through ports at multiple locations along a primary direction of fuel flow through the oxidation zone.

At 408, the fuel is oxidized in the reaction chamber. The fuel communicated into each oxidation zone may be oxidized the oxidation zone where it is received. The fuel may be oxidized in the oxidation zone(s) below a temperature that causes formation of nitrogen oxides. The oxidation reaction may be initiated by raising the temperature of the fuel to or above an auto-ignition temperature of the fuel. The maximum temperature of the fuel in the reaction chamber may be maintained at or below the temperature that causes formation of nitrogen oxides. The fuel may be oxidized by a gradual oxidation process that oxidizes the fuel to completion and/or reduces or prevents formation of carbon monoxide.

The fuel is communicated through the reaction chamber in the primary direction of flow. The primary direction may be defined, for example, by relationships among fuel inlet ports, the reaction chamber outlets, the internal structure of the reaction chamber, and/or the internal geometry of the reaction chamber. Some localized flow paths and flow transients in the reaction chamber may have flow directions that are not parallel to the primary direction of flow. For example, local and transient flows may change directions to accommodate various structures, textures and flow inlet and outlet orientations in the reaction chamber. Despite the presence of such local flow transients and diversions, on average at a macroscopic level, the fluid flows through the reaction chamber in the primary direction of fuel flow.

Temperatures in the reaction chamber may be controlled by controlling a rate of fuel flow into the reaction chamber and/or by other types of control flows in the reaction chamber. In some cases, the temperature of fluids in the reaction chamber is detected. The temperature of an oxidation zone may be decreased by reducing a rate of fuel flow into the oxidation zone and/or by communicating cool non-reactive gas into the oxidation zone. The temperature of an oxidation zone may be increased by increasing a rate of fuel flow into the oxidation zone and/or by communicating high energy fuels into the oxidation zone. Additional and/or different techniques may be used to control temperatures in the reaction chamber.

At 410, thermal energy from the oxidation product is converted to rotational mechanical energy. For example, the oxidation product can be used to drive a turbine, such as the turbine 106 of FIG. 1. The oxidized fuel may be communicated to the turbine from the reaction chamber through one or more reaction chamber outlets. Driving the turbine may include receiving the oxidation product into the turbine through an inlet of the turbine, expanding the oxidation product in the turbine, and communicating the expanded oxidation product out of the turbine through a turbine outlet. Expanding the oxidation product in the turbine may convert heat energy of the oxidation product to rotational movement of the turbine. The rotational movement of the turbine may be transferred to other system components and/or to other systems. For example, the turbine may be coupled to a shaft that drives a compressor, a generator, and/or another type of system or system component.

From the turbine, the oxidation product may be communicated to a heat exchanger, which may transfer and/or utilize remaining heat energy from the oxidation product gas. For example, the oxidation product gas may be communicated to the heat exchanger 108 of FIG. 1, where heat energy from the oxidation product gas can be used to pre-heat an air/fuel mixture prior to communicating the air/fuel mixture into the reaction chamber.

A number of embodiments have been described. Nevertheless, it will be understood that various modifications may be made without departing from the spirit and scope of this disclosure. Accordingly, other embodiments are within the scope of the following claims.

What is claimed is:

1. A system for oxidizing fuel, the system comprising:
an oxidation reaction chamber;
an inlet to the oxidation reaction chamber arranged to receive a substantially homogeneous air/fuel mixture; and
a gas distributor system in the oxidation reaction chamber and coupled to the inlet, the gas distributor system adapted to distribute the air/fuel mixture at a plurality of discrete locations throughout the interior of the oxidation reaction chamber such that when the fuel of the distributed air/fuel mixture is oxidized in the reaction chamber, heat released by the oxidation maintains a temperature substantially throughout the reaction chamber sufficient to oxidize the fuel in the air/fuel mixture.

2. The system of claim 1, wherein the gas distributor system is adapted to distribute the air/fuel mixture at a plurality of discrete locations about the interior of the oxidation reaction chamber such that when the fuel of the distributed air/fuel mixture is oxidized in the reaction chamber, heat released by the oxidation maintains a temperature substantially throughout the reaction chamber sufficient to oxidize the fuel in the air/fuel mixture and below a temperature that causes formation of nitrogen oxides.

3. The system of claim 1, wherein the heat released by the oxidation maintains a temperature throughout at least 90% of the internal volume of the reaction chamber at a temperature sufficient to oxidize the fuel in the air/fuel mixture.

4. The system of claim 1, further comprising:
a second inlet to the oxidation reaction chamber arranged to receive the substantially homogeneous air/fuel mixture; and
the gas distributor system comprises:
a first gas distributor in the oxidization reaction chamber and coupled to the first mentioned inlet, the first gas distributor dispersing the air/fuel mixture at a first plurality of discrete locations about the interior of the oxidation reaction chamber; and
a second gas distributor in the oxidation reaction chamber and coupled to the second inlet for dispersing the air/fuel mixture at a second, different plurality of discrete locations about the interior of the oxidation reaction chamber.

5. The system of claim 1, wherein the air/fuel mixture cannot sustain a flame.

6. The system of claim 5, further comprising a supplemental gas distributor in the oxidation reaction chamber and arranged to receive a supplemental fuel at a higher concentration or energy per unit mass than the fuel of the air/fuel mixture.

7. The system of claim 1, wherein the gas distributor system further comprises a plurality of ports adapted to output the air/fuel mixture into the interior of the oxidization reaction chamber, the ports arranged substantially throughout the oxidation reaction chamber.

8. The system of claim 1, wherein the oxidation reaction chamber defines a primary direction of air/fuel mixture flow from the gas distributor system to an outlet of the oxidation reaction chamber; and
wherein the gas distributor system further comprises a plurality of ports residing at discrete, spaced-apart locations substantially along the primary direction of air/fuel mixture flow, the ports adapted to output the air/fuel mixture into the interior of the oxidation reaction chamber.

9. The system of claim 1, further comprising a heater in the oxidation reaction chamber adapted to produce heat in addition to the heat released by oxidation of the air/fuel mixture.

10. The system of claim 1, further comprising a fill material in the oxidation reaction chamber that absorbs heat from oxidation of the air/fuel mixture and imparts heat to the unoxidized air/fuel mixture.

11. The system of claim 1, further comprising a supplemental gas inlet into the reaction chamber arranged to receive a supply of supplemental cooling gas.

12. The system of claim 1 wherein, in addition to air and fuel, the substantially homogeneous air/fuel mixture comprises other gases.

13. The system of claim 1 wherein the air/fuel mixture comprises fuel from multiple fuel sources.

14. A method of oxidizing fuel, the method comprising:
distributing a substantially homogeneous air/fuel mixture into an oxidation reaction chamber at a plurality of discrete locations about an interior of the oxidation reaction chamber, the oxidation reaction chamber having an internal temperature sufficient to oxidize the fuel in the air/fuel mixture; and
retaining the air/fuel mixture in the oxidation reaction chamber as the fuel of the air/fuel mixture oxidizes and the heat released by the oxidation maintains a temperature substantially throughout the reaction chamber at a temperature sufficient to oxidize the fuel in the air/fuel mixture.

15. The method of claim 14, wherein the heat released by the oxidation maintains a temperature substantially throughout the reaction chamber at a temperature sufficient to oxidize the fuel in the air/fuel mixture and below a temperature that causes formation of nitrogen oxides.

16. The method of claim 14, wherein retaining the air/fuel mixture in the oxidation reaction chamber as the fuel of the air/fuel mixture oxidizes comprises retaining the air/fuel mixture at a pressure above atmospheric.

17. The method of claim 14, controlling the temperature substantially throughout the reaction chamber by at least one of changing a rate of flow of the air/fuel mixture distributed into the oxidation reaction chamber, changing a ratio of the fuel and air in the air/fuel mixture, operating a heater in the oxidation reaction chamber, or providing supplemental gases into the oxidation reaction chamber.

18. The method of claim 14, wherein the heat released by the oxidation maintains a temperature throughout 90% of the interior volume of the reaction chamber at a temperature sufficient to oxidize the fuel in the air/fuel mixture.

19. The method of claim 14, wherein the air/fuel mixture cannot sustain a flame.

20. The method of claim 19, further comprising supplying a supplemental fuel at a higher concentration or energy per unit mass than the fuel of the air/fuel mixture.

21. The method of claim 14, wherein the oxidation reaction chamber defines a primary direction of air/fuel mixture flow from a gas distributor system to an outlet of the oxidation reaction chamber; and
wherein distributing a substantially homogeneous air/fuel mixture into an oxidation reaction chamber at a plurality of discrete locations about the interior of the oxidation reaction chamber comprises distributing the substantially homogeneous air/fuel mixture into the oxidization chamber at a plurality of discrete locations substantially along the primary direction of air/fuel mixture flow.

22. The method of claim 14, further comprising cooling the oxidized fuel prior to providing it to a turbine.

23. The method of claim 14, further comprising oxidizing any volatile organic compounds and carbon monoxide in the air/fuel mixture while the air/fuel mixture in the oxidation reaction chamber oxidizes.

24. A gas turbine system, comprising:
an oxidation reaction chamber;
a gas distributor system in the oxidation reaction chamber arranged to receive a substantially homogeneous air/fuel mixture and having a plurality of ports adapted to output the air/fuel mixture into an interior of the oxidization reaction chamber, the ports arranged substantially throughout the oxidation reaction chamber;
a turbine generator comprising a turbine inlet in communication with an outlet of the oxidation reaction chamber, the turbine generator adapted to convert energy from the oxidized fuel into electricity.

25. The gas turbine system of claim 24, further comprising a compressor arranged to receive an air/fuel mixture and output a compressed air/fuel mixture to the oxidation reaction chamber.

26. The gas turbine system of claim 24, further comprising a port between the oxidization reaction chamber and the turbine generator for supplying a cooling fluid.

27. The gas turbine system of claim 24, wherein the oxidation reaction chamber defines a primary direction of air/fuel mixture flow from the gas distributor system to an outlet of the oxidation reaction chamber; and
wherein the plurality of ports reside at discrete locations substantially along the primary direction of air/fuel mixture flow.
